(19) United States
(12) Patent Application Publication
(10) Pub. No.: US 2009/0310028 A1
(43) Pub. Date: Dec. 17, 2009

(54) System for Controlling a Group of Picture Frames

(76) Inventors: Reza Sadri, Irvine, CA (US); Saied Kazemi, Irvine, CA (US)

Correspondence Address: FISH & ASSOCIATES, PC;ROBERT D. FISH, 2603 Main Street, Suite 1000, Irvine, CA, 92614-6232, US

(21) Appl. No.: 12/483,059

(22) Filed: Jun. 11, 2009

Related U.S. Application Data
(60) Provisional application No. 61/060,736, filed on Jun. 11, 2008.

(51) Int. Cl. H04N 9/64

(52) U.S. Cl. 348/718; 348/E09.038

(57) ABSTRACT

A system for controlling multiple electronic displays is presented. The system comprises a display manager capable of aggregating environmental data and deriving a context based on the data. In response to the context, the display manager can coordinate the display of content on the multiple displays. In some embodiments, the displays can be registered members of a group; a family for example.

This application claims the benefit of priority to U.S. provisional application having Ser. No. 61/060736 filed on Jun. 11, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is digital display technologies.

### BACKGROUND

Digital picture frames have recently entered the consumer market and are quickly gaining popularity. Companies including Digital Spectrum Incorporated™ of Irvine, Calif.; Ceiva Logic™, Inc. of Burbank, Calif.; and Kodak™ of Rochester, N.Y.; for example, make digital picture frames that connect to the internet. For a paid subscription to a service one can access a database of photos, share photos with friends and family, or even receive specialty content, such as news casts, weather reports, lottery results, and sports score updates. A person can display information shared or obtained via for-fee search on their local digital picture frames. Unfortunately, known picture frame products lack an ability to coordinate a display of content across multiple picture frames in response to their environments.

Ideally, consumers should be able to coordinate content displayed on multiple picture frames no matter the environment or location in which the picture frames are placed. For example, family members distributed throughout the world could have a picture frame in each of their own homes. All the picture frames of the family, no matter of their location, could simultaneously display family vacation images on all the frames. An additional example includes displaying a congratulatory message, or possibly training material, on all digital picture frames located in a corporate environment for achieving a sales objective.

U.S. patent publication 2007/0238934A1 to Viswanathan describes devices, including picture frames, which can be configured in response to a detected mood. Sensor data is collected and compared to a model representing a mood. When the data sufficiently corresponds to the model, the device is configured according to a policy. Although useful for configuration or reconfiguration of devices, Viswanathan fails to provide for coordinating a display of content across multiple picture frames.

Thus, there is still a need for a system where the display of content can be coordinated across a plurality of picture frames.

### SUMMARY OF THE INVENTION

The inventive subject matter provides apparatus, systems and methods in which multiple electronic picture frames can interact with each other in a coordinated fashion based a context derived from environments where the picture frames are located. In preferred embodiments, the picture frames interact with each other over a packet switched network (e.g., a LAN, WAN, VPN, Internet, peer-to-peer network, etc.) to receive or send data. A display manager having roles and responsibilities for coordinating the playing of content can aggregate environmental data from one or more data sources (e.g., sensor data local to the picture frames, sensors near picture frames, remote web servers, etc.). The display manage can update at least two picture frames with content in response to a context derived from the environmental data aggregated from the various sources. It is specifically contemplated that each picture frame can function as a display manager for a group of picture frames. In other embodiments, a remote display web based server can operate as the display manager for one or more groups of frames, possibly operating as a for-fee display coordinating service. One should appreciate that coordination of content on at least two picture frames can include playing synchronized content, playing different content at least two picture frames, playing related content one the picture frames, or other forms of playing content according to the context.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic overview of a system where a display of content is coordinated among many picture frames.

FIG. 2 is a block diagram of a picture frame.

FIG. 3 is a block diagram of example picture frame group topologies.

FIG. 4 illustrates a possible representation of environmental attribute values.

FIG. 5 illustrates a pseudo code example of a defined profile having an environmental context.

### DETAILED DESCRIPTION

The following discussion describes the inventive subject matter within the preferred context of digital picture frames. One should appreciate that concepts presented herein can be equally applied to any form of electronic displays including televisions, monitors, computers, GPS devices, cell phones, PDAs, HUDs, media players, bill boards, or other devices adapted with a display.

### Overview

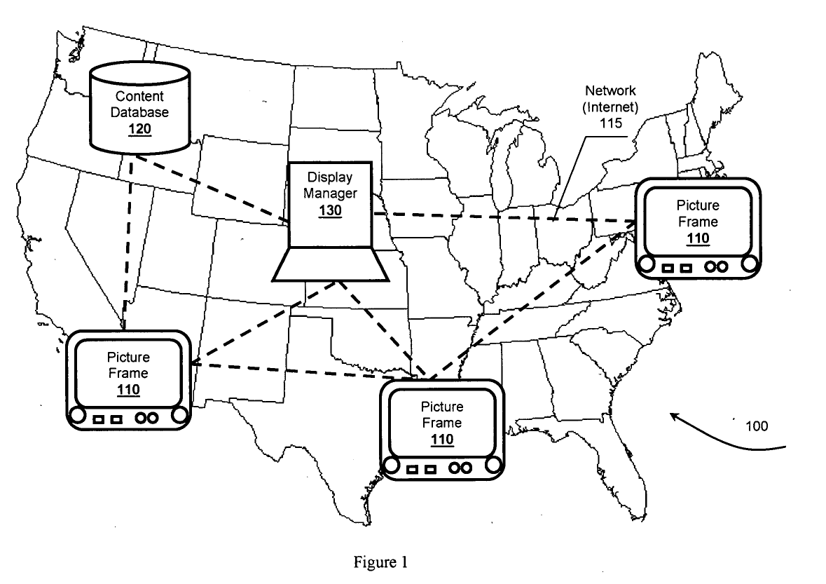

In FIG. 1, system 100 for controlling a plurality of picture frames 110 includes a plurality of frames 110, and at least one display manager 130. System 100 can also include one or more of content database 120 accessible to display manager 130 or frames 110. In preferred embodiments, the frames 110 are interconnected over network 115 and can be distributed over geographically significant distances (e.g., greater than 10 Km, even greater than 100 Km, or more). Preferably, each frame 110 can connect to display manager 130 over network 115. It is contemplated that in some embodiment, one of frame 110 could operate as display manager 130 or even as content database 120.

One should appreciate that the various devices discussed herein are considered to be computing devices having a processor configured to execute software instructions stored on a computer readable medium. The software instructions represent programmatic functionality for performing the objectives of the devices. For example, contemplated computing devices include databases, servers, digital picture frames 110, or other devices.

In some embodiments, multiple computing devices coordinate their behaviors to fulfill the roles or responsibilities of a described element. For example, a server can be embodied by multiple computer servers working together as a server farm, or a database can be embodied by one or more computers storing indexed data on one or more storage devices (e.g., HDDs, SSDs, file systems, RAID devices, etc.).

Network 115 preferably comprises a packet switched network infrastructure, possibly including the Internet. Other contemplated network infrastructure include local area networks, wide area networks, home networks, office networks, Intranets, or other networks capable of transporting digitized data. Network 115 can include wired or wireless network devices.

Network 115 also euphemistically refers to a logical network of interconnected of picture frames 110, where the pictures frames 110 can contact and communicate with each other via the networking infrastructure, intermediary networking devices, or each other. Picture frames 110 can be arranged in various logical networks of various topologies including a mesh network topology, peer-to-peer network topology, hierarchical network topology, star network topology, or other logical topologies that allow frames 110 to exchange data. Logical networks are typically configured above a transport layer (e.g., TCP, UDP, etc.) of a communication stack.

One should appreciate that there could be multiple, distinct networks of frames 110 that co-exist. For example, a first family could have a first network 115 of ten picture frames 110 located throughout the world, where the ten frames 110 communicate with each other via a mesh or peer-to-peer topology. A second family could have over a second network of a hundred or more picture frames 110 within the same state that communicate with each other through a hierarchical topology. The first and the networks do not interact with each other. Still, it is contemplated that both networks could engage with display manager 130 or content database 120.

### Digital Picture Frames

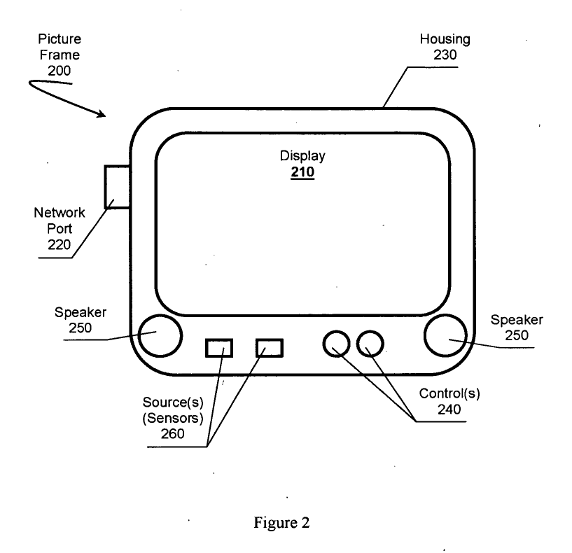

In FIG. 2, picture frame 200 preferably is configured to appear similar to a traditional picture frame. Frame 200 preferably includes housing 230 forming a frame that holds a digital display 210. In a preferred embodiment, frame 200 also includes at least one of network port 220 configured to communication over a network. Picture frame 200 can optionally include one or more environmental data sources 260, one or more controls 240, or speakers 250. Picture frame 200 is considered a computing device and also includes desirable processors, computer readable memory, power supply, or other desirable components for enabling frame 200 to operate. An example picture frame that can be adapted for use with the inventive subject matter includes the MF-8104 Premium Wireless Digital Frame available from Digital Spectrum Solutions, Inc. of Irvine Calif. (http://www.dsicentral.com). Frame 200 can be configured to rest on a horizontal surface (e.g., shelf, table, counter, etc.) with one or more stands, or can be configured to hang on a vertical surface (e.g., wall, bulkhead, etc.). Additional information about digital picture frames can be found in co-owned U.S. Pat. No. 6,826,863 titled “Combination Video Monitor And Detachable Picture Frame” (December 2004).

Digital picture frames 200 can be distinguished from other computing devices that can play media. As discussed herein, digital picture frames are considered to have a dedicated application stored in a memory where the application is configured to present previously recorded media. The media can be obtained locally from a memory within frame 200 or remotely via port 220. A preferred digital picture frame 200 comprises a display having a frame with no visible controls 240 in or on the frame surrounding the display.

Preferred picture frames 200 include electronic display 210 configured to display image based content. Frame 200 can display still photographic images, recorded video images, computer generated images, or other image based content. In an especially preferred embodiment, display 210 can comprise a touch sensitive screen to allow users to interact with content. For example, a user could control various aspects of display 200 including volume, brightness, contrast, channels, group affiliation, or other control aspects via a user interface presented in display 210. Additionally, frame 200 can include a web browser functionality that allows frame 200 render web pages on display 210, through which a user can interact with remote computing devices including a display manager, a content database, other frames 200, or other devices offering web services.

Preferred frames 200 include sufficient computer readable memory to store playable content. For example frame 200 could include a flash module, hard disk drive (HDD), solid-state drive (SSD), or other types of memory. Preferred memories support read/write capability that can be managed by remote managers (e.g., a display manager) if desired. Memories can have a capacity of at least one Gigabyte (GB), more preferably 100 GB, and yet more preferably at least 1 Terabyte (TB). In some embodiments, the memory can be disposed on a swappable module possibly based on a memory stick, SD card, SSD, thumb drive, or other types of removable memory modules.

Display 210 can be partially surrounded by housing 230 in a manner that presents display 210 as a traditional picture frame. Housing 230 can comprise various suitable framing materials including plastics, wood, metal, ceramic, or other framing materials. It is also contemplated that housing 230 can comprises a bezel or frame that can be removed or replaced easily for to allow for customization of display 200 by a user.

Picture frame 200 can also comprises one or more of controls 240 to allow a user to control functional aspects of frame 200. Controls 240 can include buttons, knobs, sliders, touch sensitive displays, thumb wheels, stylus, or other known controls or those yet to be invented.

In some embodiments, picture frame 200 can also include one or more of sensors 260 that represent sources of environmental data local to frame 200. Sensors 260 can include microphones, cameras, GPS, thermometers, barometers, accelerometers, compasses, motion sensors, or other types of sensors for gathering environmental data local to frame 200. As used herein, “local” is used to mean within 10 meters of frame 200. In a preferred embodiment, sensors 260 collect at least one of image data and audio data local to frame 200 that can be used to identify individuals near the frame 200, or used to exchange video chat data. As frame 200 collects or gathers environmental data from sensors 260 or other local environmental data sources, the collected data can be sent to a display manager, possibly for further analysis or comparison against defined environmental contexts or profiles.

Frame 200 preferably includes a frame identifier that is persistently stored within frame 200, possibly in read only memory (e.g., flash, ROM, EEPROM, hardware defined registers or resistors, etc.). The frame ID can take on many different forms. A preferred frame ID includes a permanently assigned ID possibly comprising a MAC address, GUID, UUID, serial number, date or time of manufacture, or other encoding that preferably uniquely identifies the frame. The frame ID can also comprise a transient component encoding that could change during use including an IPv4 address, IPv6 address, a URL, an email address, a name, or other temporary encoding. The frame ID can be used to register a frame 200 with a web-based service, a display manager, a content database, other frames 200, or with other network entities.

In a preferred embodiment, two or more picture frames can be members of a group. For example, multiple frames belonging to various members of a family could register as members of the family's group. Alternatively, picture frames in a corporate environment could register as members of the company, a division, a department, or other affiliation. Preferably the frames register their affiliation with a display manager. Contemplated types of groups include family, corporate, workgroup, common interests, subscribers to on-line content (e.g., blogs, magazines, etc. . . . ), or other forms of affiliation.

### Display Manager Responsibilities

A display manager in the contemplated system has many roles or responsibilities for coordinating the display of content on member frames as discussed below. Some of the roles or responsibilities include management of frame groups, aggregation of environmental data, management of contexts, management of profiles, coordinating display of content on frames, or other management activities.

### Display Manager Responsibilities: Group Management

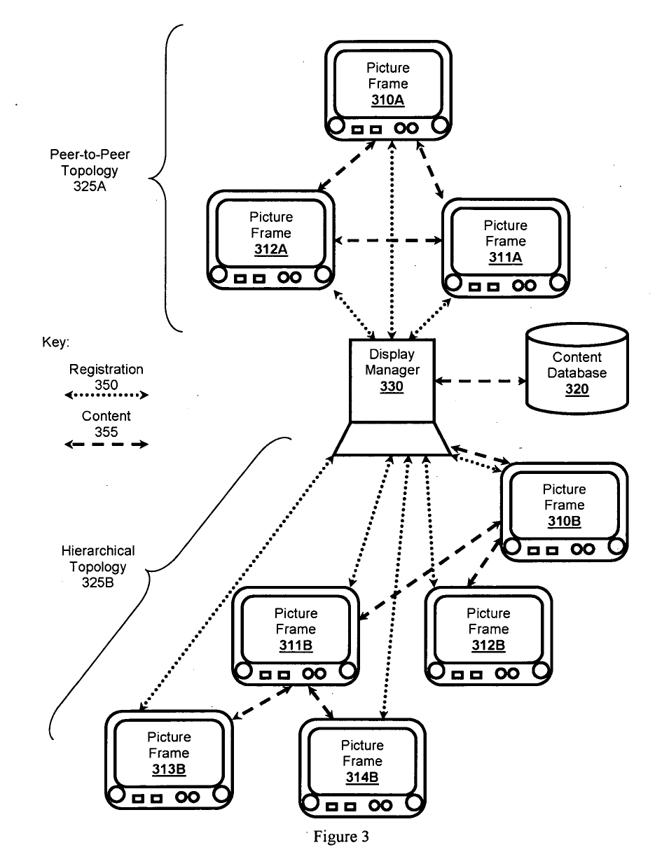

In FIG. 3, display manager 330 coordinates one or more groups of picture frames 310A, 311A, and 312A; and 310B, 311B, 312B, 313B, and 314B. In some embodiments, the frames can register themselves with display manager 330 in preparation for joining one or more groups. FIG. 3 illustrates that a single display manager 330 can coordinate more than one distinct group at a time, or can coordinate multiple groups having distinct topologies.

In some embodiments, a frame can register with display manager 330 by sending the frame's frame ID to manager 330. Manager 330 can communicate with the frame by correlating the frame ID with a network address of the frame. Manager 330 can also correlate the frame ID with a group ID representing a group of frames. Manager 330 can also provide the frame ID to other members of the group or possibly content database 320 as necessary. Frame IDs or group IDs can be easily correlated via a look-up table or via other indexed database schema.

As an example, FIG. 3 presents two possible group affiliations. One should note that other group affiliations having different group topologies are also contemplated. In the example shown, frames 310A through 314B have registered with display manager 330 to form groups having a peer-to-peer topology 325A, or a hierarchical topology 325B.

Topology 325A represents an organization of the frames where each frame exchanges data directly with other frames without requiring a data exchange through display manager 330. It is also contemplated that each of frames 310A through 312A could obtain content directly from content database 320 if desired, or through their peers. It is thought that peer-to-peer topology would be useful for a small number of peer frames (e.g., less than 10) to ensure communication overhead is kept low. In some peer-to-peer embodiments, communication overhead can be reduced by pushing desirable content to each of frames 310A through 312A, and merely providing instructions to each of the frames dictating which locally stored content should be played at which times. If local content is missing, a frame can play a default content in stead. Such an approach could be implemented by sending instructions in real-time, sending instructions periodically, or possibly sending instructions as a batch of instructions. In some embodiment, the instructions simply include a repeat instruction that causes the frame to continuously play through a programmed play list.

Hierarchical topology 325B represents an organization of frames where each of frames 310B through 314B exchanges data directly with other frames via a root frame, and where the frames are arranged within hierarchical levels. For example, frame 310B represents the root for the entire group. Frame 310B exchanges data with frames 311B and 312B. In turn, frame 311B acts as a root for frames 313B and 314B. It is also contemplated that hierarchical topology 325B could be arranged as having two, three, four, or more levels. Topology 325B could also be implemented as a binary tree or other hierarchical arrangement as necessary to facilitate connectivity or communications while reducing various overheads.

The example group topologies presented in FIG. 3 are for example only, and should not be considered limiting. Other topologies are also contemplated including mesh topologies, N-cube topologies, star topologies, ring topologies, tree topologies, bus topologies, linear topologies, hybrid topologies comprising elements of multiple topologies, or other topologies. Furthermore, the number of frames in a group could vary greatly from the number depicted. For example, a group could comprise two, three, five, ten, 100, or even more frames.

In embodiments having a centralized display manager 330, manager 330 can organize the frames into groups by assigning a group ID to the group. Frames associated with the group can have their frame ID's bound to the group ID. A group ID can also take on many forms including a name, GUID, UUID, a data structure, or other forms of encoding that preferably uniquely identify the group. Groups preferably also have a human readable group name. For example, “The Sadri Family”, “DSI Engineering Group”, or other text based names could be used as a group name. The group names do not necessarily have to be unique. The group topology, group organization, or group data routing paths can be sent from manager 330 to members of the group, or the group heads for further dissemination to remaining group members. Once the group members have their group information, they can then interact with each other directly or possibly through display manager 330.

It is specifically contemplated that manager 330 can change a topology of a group from a first topology to a second, different topology as desired. For example, as the number of frames in a group expands, the topology of the group could be changed from a peer-to-peer topology 325A to a hierarchical topology 325B. Such an approach facilitates scaling a group while minimizing cost or traffic overheads. In a preferred embodiment, manager 330 can organize a group transparently while members of the group continue to display coordinated content.

### Display Manager Responsibilities: Environmental Data Aggregation

Display manager 330 preferably has the responsibility for aggregating environmental data from sources local to the frames. Environmental data can be aggregated from nearly any network accessible source. Environmental data can be collected from sources internal to a picture frame possibly via one or more sensor or external from the picture frame. Sensors can comprise microphones, cameras, accelerometers, thermal sensors, GPS, orientation sensors, or other data acquisition devices, preferably disposed within the frames. Additionally, environmental data can be acquired from sources considered external from a picture frame. Examples of externally obtained data includes radio broadcasts, television broadcasts, national or international emergency systems, weather services, internet sites, or other sources of data external with respect to the frames and the display manger. It is also contemplated that individuals could supply environmental data through one or more interfaces including web page served from a frame or display manager 330, or even an API that can be accessed programmatically possibly over a network as a web service.

As the environmental data is aggregated, the data is analyzed to extract information for use in deriving a context. Preferably, analysis of the data yields one or more attribute values representing characteristics of the environment. The attribute values can represent results obtained from analyzing facial recognition data, voice recognition data, environmental conditions, or other measurable data. Contemplated attribute values can include digital encodings of numbers, text, or other digital values. Known techniques can be utilized to analyze environmental data to yield attribute values. Analysis of the environmental data can occur on the frames, the data manager, other computing devices, a remote web service, or any combination of devices.

Preferred environmental data associates an attribute value with a source for the corresponding environmental data, or an attribute name. For example, an attribute value encoding a temperature can be associated with specific thermal sensor on a specific frame as determined by the frame's frame ID. Another example includes an attribute value representing a person's name. The person could have been identified as speaking near or as imaged near a frame once the frame's environmental data is analyzed. The source frame's ID could be stored with the person's name. The source information could have finer granularity than a frame ID by including a sensor ID.

In a preferred embodiment, data manager 330 collects ambient environmental data that is continuously collected by the frames. The environmental data can be aggregated in real-time, or collected periodically as desired. It is also contemplated that the frames can be instructed to exchange environmental data with manager 330 when a frame detects an a priori defined trigger condition.

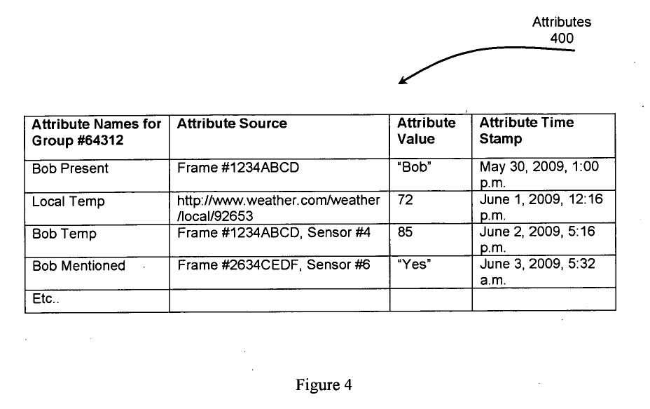

FIG. 4 presents a table having example attributes 400 with their attribute names, sources, values and a time stamp. Preferably attributes 400 are associated with a specific group. One should also note that the environmental data as represented by attributes 400 can represent data collected from at least two distinct ones of the picture frames, or even more distinct frames regardless of their locations. Attributes 400 can comprise additional information beyond what is illustrated including geographic location, an indicator showing the values as public or private, last time updated, access authorization level, relative priority of attribute values, or other information.

### Display Manager Responsibilities: Environmental Context

A display manager can coordinate a display of content in response to a derived environmental context. Upon correlating the context with one or more predefined profiles, the display manager can obtain content from one or more content sources. Content can be referenced by a URL for example. The content can then be displayed on the picture frames according to a configured set of preferences or rules set in the profile. It should be noted that the act of displaying content can include the concept of playing a media where the media can include a still image, a slide show, a video, audio data, or other forms of media. Preferably, the display manager controls the content display among frames registered to the same group.

Preferably a display manager also manages user defined environmental profiles that govern the coordination of displayed content among members of a group. Preferred profiles include one or more condition that describe an environmental context and that depend on environmental data attribute values. Contemplated conditions can comprise various operators that can programmatically operate on the attribute values including Boolean operators (e.g., AND, OR, NOT, etc.), mathematical operators (e.g., +, −, *, /, etc.), or other operates capable of forming simple or complex rules.

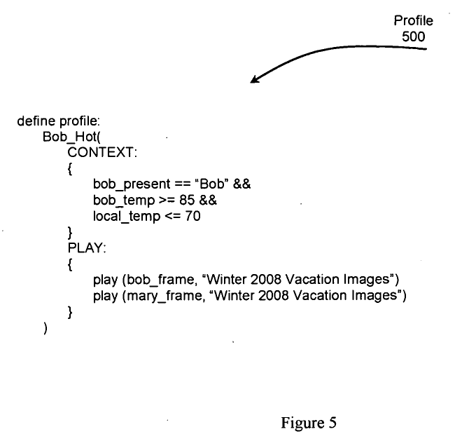

Preferred profiles also include instructions with regards to playing content on member frames of a group. The profile can identify which content is to be display at which time on which of the frames. FIG. 5 presents a pseudo code example of a possible profile 500 definition where the profile has a defined name, rules, and play instructions targeting different frames. In the example illustrated in FIG. 5, if a display manager derives a context from environmental data indicating that Bob is present and that Bob's frame is hot relative to a local temperature. If the derived context is satisfied, then Bob's display should show winter time pictures. Similar pictures can also be played on Mary's frame as well. One should note that a profile, context, or play instructions could vary widely without departing from the inventive subject matter and can could be quite complex.

The context defined in FIG. 5 should be recognized as being a simple context. One should appreciate that an environment context can be defined as depending on an environment for a single frame, for at least two frames in a group, or for all frames in a group. An environment be larger than just local to the frames and could include a postal code, area code, county, state, country, region, or other geographical area. Additionally, the environmental context can depend on non-local environment data obtained elsewhere. For example, the context could depend on local news reports, weather conditions, stock prices, or other information possibly obtained over the Internet via a URL.

FIG. 5 illustrates play instructions that instruct specific players to play a named set of content. One should appreciate that the play instructions could control many aspects of playing a target media. Contemplated aspects include changing volume, change brightness or contrast, adjusting ambient lighting around a frame, placing content in just a portion of a frames display (e.g., a window), turning off a frame's display when no-one is around to save power, or otherwise controlling aspects of the frame in response to the environmental context.

In a preferred embodiment, a context can be derived by combining a plurality of value attributes together in a data structure representing the current state of the environment. A context can be considered a multi-parameter data structure where each member corresponds to a potential property of the environment, and where the data structure members comprise one or more of the attribute values. In some embodiments, a context correlates to one or more established profiles (e.g., pre-defined contexts) having a priori defined sets of attribute values associated with environmental data.

It is contemplated that profiles can be defined to correspond to user profiles for authentication (e.g., recognized face or voice), emergencies (e.g., increase in temperature due to fire), weather alerts, moods (e.g., raised volume of voices), or other desirable conditions triggered by appropriate selection of attribute values. When a display manager determines that the attribute values correspond match a context of a defined profile, the manager can then provide instructions to members of the group to play specific content as determined by the rules or preferences of the profile.

Content profiles can be defined to operate on all members of a group, portions of the group, or for a single frame. Consider for example a group comprising ten frames spread throughout the world belonging to ten different family members. If one frame detects a “Happy Birthday” song, a display manager could check for a context having the attribute values of “Happy Birthday”. If found, the display manager could then correlate the context with known profiles. If a profile is found the display manager can instruct all frames in an associated group to display birthday pictures on the frames. Alternatively, if two members of the family are talking to each other on the telephone and their frames detect the conversation, the display manager could instruct the frames to display pictures of the conversing family members. Yet another example includes a first family member that merely mentions another family member's name, the display manager can identify a context targeting the first family member's frame and instruct the frame to display images of the other family member.

Content profiles can include rules for displaying content that depend on many factors. As discussed above, the rules can depend on environmental attributes value. The rules can also depend on frame ID, geographic location, date or time, permission levels, authorization, or other information.

Although a preferred embodiment coordinates a display of content based on an environmentally derived context and profiles, it also contemplated the display of content can also be coordinated in response to other, non-environmental profiles. An example of a non-environmental profile can include a programmed profile that provides instructions to play media on a target frame according to a viewer's preferences regardless of environmental stimuli.

In some embodiments, the display manager can be configured to display content to only those individuals that are authorized to view the media. For example, a display manager can use a derived context that includes voice or facial recognition data to determine which individuals are local to a picture frame. The manager could authenticate an individual based on how well the current context matches a person's stored profile (e.g., the person is the only person detected). If there is a sufficient match, the display manager could present content to the individual via the picture frame. It is also contemplated, that the display of content can be restricted if one or more unauthorized individuals appear to be present.

### Display Manager Responsibilities: User Interfaces

Yet another responsibility of the display manager can include providing one or more user interfaces through which users can define contexts, define profiles, conduct group management activities, register frames, or otherwise manage their picture frames. User interfaces can be presented via known techniques including utilizing a web server to instruct a browser to render a user interface. For example, in some embodiments, a display manager resides a centralized web server remote relative to a plurality of picture frames. A browser application on a picture frame or other computing devices can be directed to the web server to access the user interface for the system.

A user interface preferably allows users, assuming proper authentication, to easily define one or more desired contexts or profiles. A defined environmental context of a profile could have varying degrees of dependency with respect to a group of frames, from encompassing an entire group, a portion of a group, or a single frame. Preferably the user interfaces allow users to drag and drop objects to creating a desired context or profile without requiring a user to enter programmatic code. Users can preferably create, define, update, modify, or otherwise configure contexts or profiles.

In a similar fashion a group user interface allows users to manage their groups. Users can create groups, join groups, name a group, delete groups, add member frames to a group, or otherwise modify a group's definition.

A display manager can also include many other roles or responsibilities, including the following for examples:
Providing firmware updates to digital picture frames.
Providing content for local storage by a digital picture frame.
Synchronizing a display of content on multiple frames.
Providing name services to allow frames to contact each other after registration.
Providing an interface to store or retrieve content from a content database.

In a preferred embodiment, a display manager operates as a separate computing device possibly as a for-fee web based service. Such a service provides for management of coordinated displaying of content or for storing content in a content database. It is also contemplated, that an individual frame could adopt the roles or responsibilities of a display manager for a specific group. In such an embodiment, a web base service could provide just a name service to allow frames to find, identify, authorize, or otherwise connect to each other.

One should note that a source of content preferably includes a network accessible content source. Sources can include data files, data feeds, data streams, radio broadcasts, television broadcasts, other picture frames, cell phones, databases, file systems, or other sources capable of storing or disseminating content. The content can be sent or pushed to the frames using many suitable techniques including FTP, TFTP, SSH, HTTP, HTTPS, BitTorrent, CIFS, SMB, SCP, or other protocols used for data transport.

A coordinated display of content represents the controlled playing of related media on two or more frames. Examples of coordinated display of content include the follow:
Displaying duplicated content on two or more frames. For example, geographically distributed picture frames that are members of a family group could simultaneously display images of the family's vacation. Alternatively, multiple frames in the same home could simultaneously display the same family videos so an individual can view the videos as they move about the home. The frames do not necessarily have to be synchronized.
Displaying different portions of content on two or more frames. For example, frames can be joined together to form a composite picture frame, or possibly a large wall display. The display manager could divide the content into portions where each frame of the composite display would display only the portion it receives from the display manager. The collection of frames, in aggregate, would present the complete content.
Displaying content on a first frame and displaying related, yet different content one a second frame. For example, a first frame in a room might be displaying a sporting event. The display manager could detect the sporting event, or be programmed to respond to the sporting event by displaying sports scores for other sporting events on a second frame. Another example includes playing images of a remote person on a local display, while playing images of a local person on the remote display as the to people talk on the telephone.
Displaying an advertisement on one of the frames. For example, during a video chat among family members regarding a vacation, each frame could display a ticker showing hotel prices for hotels local to each member of the family.

Contemplated applications for the disclosed subject matter include using the picture frames for video chats, as a digital window into a family member's home, a shared media experience where a family spread throughout the world can watch a movie together, or other similar applications. Interestingly, for most applications there is little requirement for synchronizing content among members displays. In most uses, the displays merely plays pre-recorded content based a derived context from ambient environmental data.

The advantages of the inventive subject matter can be further appreciated through an example. Consider a scenario where two grand children are using picture frames for a video chat and are discussing their grandfather. A display manager monitors and aggregates environmental data relating to the chat by possibly analyzing audio data exchanged between the two grandchildren. The display manager can then detect that the grandfather is being discussed from the context derived from the chat, possibly based on detecting the words “grandfather”, “grandpa”, or other relevant words. In response, the display manager can begin displaying content on the grandfather's picture frame relating to the grandchildren or their chat. In such an approach, a context is derived from a first sub-set of a plurality of picture frames while content is displayed on a second, different sub-set of frames even if the second sub-set is geographically separated from the first sub-set of frames. It is also contemplated that the grandchildren could have multiple, local frames participate in the video chat. For example, one of the frames can provide a display of the remote chat partner while another frame can display of view of what the remote partner would see.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for controlling a plurality of picture frames, the system comprising:
a plurality of digital picture frames;
a plurality of sources of environmental data;
a display manager configured to (a) aggregate the environmental data from the plurality of sources, and to (b) coordinate a display of content on at least two of the plurality of picture frames in response to a context derived from the environmental data; and
a network interconnecting the plurality of picture frames, the plurality of sources, and the display manager.

2. The system of claim 1, wherein at least one of the plurality of picture frames comprises the display manager.

3. The system of claim 1, wherein the display manager resides on a centralized server remote relative to the plurality of picture frames.

4. The system of claim 1, wherein the at least two of the plurality of picture frames are physically separated by more than 10 Km.

5. The system of claim 1, wherein at least one of the plurality of picture frames comprises a sensor configured to acquire the environmental data from sources local to the at least one of the plurality of picture frames.

6. The system of claim 5, wherein the environmental data comprises at least one of image data and audio data.

7. The system of claim 5, wherein the environmental data comprises environmental data obtained by at least two distinct ones of the plurality of picture frames.

8. The system of claim 5, wherein the context is derived from environmental data collected by a first picture frame and a second picture frame of the plurality of picture frames and the display of content occurs on a third, different picture frame.

9. The system of claim 1, wherein the network comprises a WAN.

10. The system of claim 1, wherein the network comprises a peer-to-peer network.

11. The system of claim 1, wherein the display of content includes displaying the same content on at least two of the plurality of picture frames.

12. The system of claim 1, wherein the display manager is further configured to display different portions of the content on different ones of the plurality of picture frames.

13. The system of claim 1, wherein the display manager is further configured to display content on a first display selected from the plurality of displays and related, yet different content a second, different display selected from the plurality of picture frames.

14. The system of claim 1, wherein the display manager is further configured to display an advertisement on at least one of the plurality of picture frames.

15. The system of claim 1, further comprising a content database accessible by the display manager and that stores the content.

16. The system of claim 1, wherein each of the plurality of picture frames is member of a group assigned a group ID.

17. The system of claim 1, wherein the context correlates to a profile having a plurality of attribute values associated with the environmental data.

18. The system of claim 17, wherein the profile comprises a user profile.

19. The system of claim 17, wherein the profile comprises an authentication.

20. The system of claim 1, wherein at least one of the sources is non-local with respect to the display manager and the plurality of picture frames.
